(19) United States
(12) Patent Application Publication
(10) Pub. No.: US 2018/0146818 A1
(43) Pub. Date: May 31, 2018

(54) BREWING SYSTEM FOR BEVERAGE MACHINE, BEVERAGE MACHINE AND BEVERAGE BREWING METHOD

(71) Applicants: GUANGDONG MIDEA CONSUMER ELECTRICS MANUFACTURING COL., LTD., Foshan (CN); MIDIA GROUP CO., LTD., Foshan (CN)

(72) Inventor: Jian KUANG, Foshan (CN)

(21) Appl. No.: 15/578,230

(22) PCT Filed: Aug. 26, 2015
(86) PCT No.: PCT/CN2015/088120

§ 371 Date: Nov. 29, 2017

(30) Foreign Application Priority Data
Jul. 27, 2015 (CN) 201510449721.5
Jul. 27, 2015 (CN) 201520553418.5

(51) Int. Cl. A47J 31/56; A47J 31/40

(52) U.S. Cl. CPC A47J 31/56; A47J 31/407

(57) ABSTRACT

Provided are a brewing system for a beverage machine, a beverage machine and a beverage brewing method. The brewing system for a beverage machine comprises a brewing device (1), a heating device for supplying hot water to the brewing device (1), a water pump (5) and a controller. A heating container of the heating device is in communication with the atmosphere. The heating container is connected to the brewing device (1) through a pipeline. The water pump (5) is provided on the pipeline. The controller is connected to the water pump (5). When the temperature of water in the heating container reaches a set value, the controller controls the water pump (5) to pump water into the brewing device (1).

### FIELD

The present invention relates to a technical field of beverage heating and brewing, and more particularly to a brewing system for a beverage machine, a beverage machine and a beverage brewing method.

### BACKGROUND

An existing brewing system for a beverage machine includes a brewing device and a heating device for supplying hot water to the brewing device, which can specifically refer to a brewing system for a coffee machine in the prior art. The heating device includes a closed container, and the hot water in the closed container can be drained into the brewing device by pressure, thereby achieving the effect of brewing the beverage. A defect in the prior art is that, there is a certain safety hazard existing in a heating process of the closed container.

### SUMMARY

Embodiments of the present invention seek to solve at least one of the problems existing in the related art to at least some extent. For that reason, an objective of the present invention is to provide a brewing system for a beverage machine, which is safe and stable.

Another objective of the present invention is to provide a beverage machine having the brewing system.

A further objective of the present invention is to provide a beverage brewing method for the beverage machine.

A brewing system for a beverage machine according to embodiments of a first aspect of the present invention includes a brewing device; a heating device for supplying hot water to the brewing device, a heating container of the heating device being communicated with the atmosphere, and the heating container being connected with the brewing device through piping; a water pump provided in the piping; and a controller connected with the water pump, in which when temperature of the water in the heating container reaches a predetermined value, the controller controls the water pump to pump water into the brewing device.

In the present embodiment, the brewing system for the beverage machine is supplied with water by the water pump which is provided between the brewing device and the heating device, and hence the heating container of the heating device does not need to be sealed, thereby avoiding a safety hazard existing in a heating process of a closed container. On this basis, the water pump can not only convey the water heated by the heating device to the brewing device, but also operate for a period of time after the water is drained, thereby drying the capsule and avoiding the residual liquid from causing the environment contamination.

According to an example of the present invention, the heating container is a boiler, the boiler is heated by a heating tray disposed on a bottom surface, and temperature of the water in the boiler is measured by a temperature sensor, the temperature sensor being connected with the controller.

According to an example of the present invention, the heating tray is connected with a temperature controller and a fuse.

According to an example of the present invention, the bottom surface of the boiler is a recessed surface.

According to an example of the present invention, the brewing device includes a barrel body for containing a beverage capsule, a bottom end of the barrel body being provided with a beverage outlet; a cover body fitted with the barrel body and provided with a water inlet; and a piercing needle separately provided to an inner bottom end of the barrel body and the cover body so as to pierce the beverage capsule.

According to an example of the present invention, a central section of the piercing needle on the cover body is hollow and forms the water inlet; the piercing needle on the cover body is seal-fitted with the beverage capsule through a sealing ring, and the sealing ring is fitted over the piercing needle on the cover body and is arranged coaxially with the piercing needle.

According to an example of the present invention, the piercing needle extends to an upper surface of the cover body and is connected with a beverage machine body, such that the water enters the water inlet from the beverage machine body.

According to an example of the present invention, the cover body is in hinged connection with the barrel body.

The beverage machine according to embodiments of a second aspect of the present invention includes the above brewing system according to embodiments of the first aspect of the present invention.

In the beverage brewing method for the beverage machine according to embodiments of a third aspect of the present invention, the beverage machine is the beverage machine according to embodiments of the second aspect of the present invention. The method includes the following steps:

S1, setting a heating temperature T for water in a heating container, and heating the water in the heating container;

S2, starting a water pump to operate when the water in the heating container reaches the set temperature T, so as to allow the water pump to pump the water in the heating container into a brewing device;

S3, controlling the water pump to continue operating for a period of time after the water in the heating container is drained and a beverage is acquired by a brewing machine, until the water pump blow-dries residual liquids in a capsule of the brewing device by drawing air.

Additional aspects and advantages of embodiments of present invention will be given in part in the following descriptions, become apparent in part from the following descriptions, or be learned from the practice of the embodiments of the present invention.

### BRIEF DESCRIPTION OF THE DRAWINGS

These and other aspects and advantages of embodiments of the present invention will become apparent and more readily appreciated from the following descriptions made with reference to the drawings, in which:

FIG. 1 is a schematic view of a brewing system for a beverage machine according to embodiments of the present invention;

FIG. 2 is a section view of a brewing device according to embodiments of the present invention;

FIG. 3 is a perspective assembly view of a brewing device according to embodiments of the present invention;

FIG. 4 is a schematic view of a beverage machine in a use state according to embodiments of the present invention.

### REFERENCE NUMERALS

1 brewing device; 2 boiler; 3 heating tray; 4 temperature sensor; 5 water pump; 6 machine nose; 7 mounting body; 11 barrel body; 12 cover body; 13 piercing needle; 14 sealing ring; 15 water inlet; 16 beverage outlet; 17 joint; 18 annular flange; 19 vertical baffle; 61 supporting rail; 62 machine nose shell; 71 waste water box; 72 base; 73 housing; 74 fixing ring; 75 top cap.

### DETAILED DESCRIPTION

Reference will be made in detail to embodiments of the present invention. The same or similar elements and the elements having same or similar functions are denoted by like reference numerals throughout the descriptions. The embodiments described herein with reference to drawings are explanatory, illustrative, and used to generally understand the present invention. The embodiments shall not be construed to limit the present invention.

In the specification, unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom” as well as derivative thereof (e.g., “horizontally”, “downwardly”, “upwardly”, etc.) may be construed to refer to the orientation as then described or as shown in the drawings under discussion. These relative terms are for convenience of description and do not require that the present invention be constructed or operated in a particular orientation.

It should be noted that, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present invention, “a plurality of” means two or more than two, unless specified otherwise.

In the present embodiment, a brewing system for a beverage machine includes a brewing device 1 and a heating device for supplying hot water to the brewing device 1. A heating container of the heating device is communicated with the atmosphere, the heating container is connected with the brewing device 1 through piping, and a water pump 5 is provided in the piping; the water pump 5 is connected with a controller, and when temperature of the water in the heating container reaches a predetermined value, the controller controls the water pump 5 to pump water into the brewing device 1.

In the present embodiment, the brewing system for the beverage machine is supplied with water by the water pump 5 which is provided between the brewing device 1 and the heating device, and hence the heating device does not need to be sealed, thereby avoiding a safety hazard existing in a heating process of a closed container.

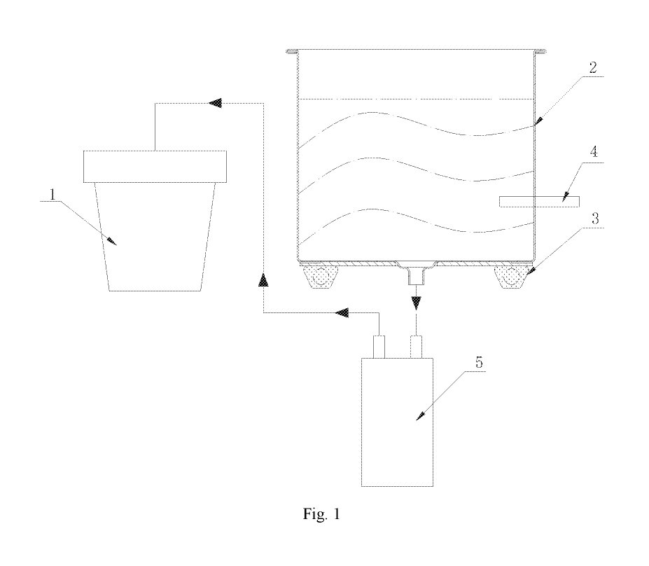

Referring to FIG. 1, the heating container of the present embodiment may be a boiler 2, and the boiler includes a boiler body and a boiler cover. Obviously, since the boiler 2 needs to be communicated with the atmosphere, the boiler cover does not serve to seal, but shield the boiler body. The boiler 2 is heated by a heating tray 3 disposed on a bottom surface, and temperature of the water in the boiler 2 is measured by a temperature sensor 4. The temperature sensor 4 transmits a measurement signal to a controller, and when the water in the boiler 2 is heated to a predetermined temperature, the controller controls the water pump 5 to operate, thereby conveying the hot water to the brewing device 1. Certainly, positions of the heating tray 3 and the temperature sensor 4 are not specifically limited, as long as the heating tray 3 and the temperature sensor 4 can achieve the objectives of heating and temperature measurement respectively. Moreover, in this case, the heating tray 3 can also be replaced by other structures which can achieve the objective of heating.

The heating tray 3 is connected with a temperature controller and a fuse, and the temperature controller and the fuse may be disposed at a bottom surface of the heating tray 3, so as to ensure safety protection.

In order to make it convenient to drain the water in the boiler 2, the bottom surface of the boiler 2 may be designed as a recessed surface. The recessed surface herein means that when the bottom surface of the boiler is seen from the interior of the boiler, the bottom surface presents an inwardly-recessed structure. Obviously, if the bottom surface is seen from the exterior of the boiler, the bottom surface of the boiler is protruded outwardly. In this case, the water at the bottom of the boiler can flow out of the boiler along an inclined angle of the bottom surface.

When the water in the boiler 2 is drained, the water pump 5 continues to operate for a period of time. In this case, the water pump 5 conveys air to the brewing device 1 and can just blow-dry the water in a capsule, thereby avoiding the residual liquid from contaminating the environment.

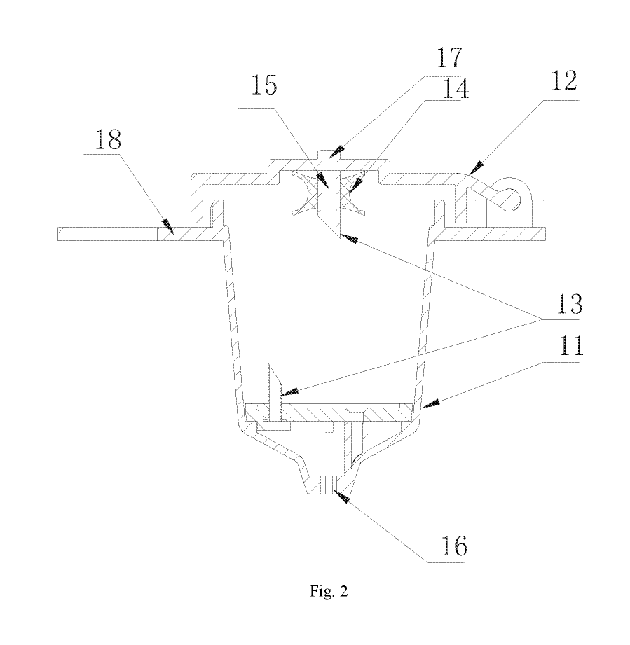

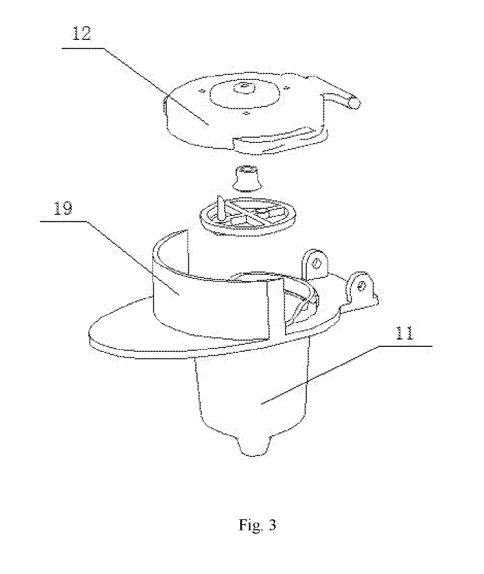

In the brewing system for the beverage machine, referring to FIGS. 2-3, the brewing device 1 includes a barrel body 11 for containing a beverage capsule, and a cover body 12 fitted with the barrel body 11. In this case, the cover body 12 may be in hinged connection with the barrel body 11, such that the cover body 12 can rotate with respect to the barrel body 11. In order to pierce the beverage capsule during brewage of the beverage, in the present embodiment, an inner bottom end of the barrel body 11 and the cover body 12 are separately provided with a piercing needle 13 for piercing the beverage capsule. When the cover body 12 is closed, the piercing needles 13 pierce an upper end and a lower end of the capsule, thereby facilitating the subsequent brewage of the beverage. In addition, the cover body 12 is provided with a water inlet 15 and the bottom end of the barrel body 11 is provided with a beverage outlet 16.

In order to ensure cleanness in a cavity of the brewing device 1, a central section of the piercing needle 13 on the cover body 12 is hollow and forms the water inlet 15. In this case, the heated water can directly enter the capsule from the boiler 2, and flow out from the beverage outlet 16 finally, thereby avoiding contamination in a brewing cavity.

On that basis, the piercing needle 13 on the cover body 12 is seal-fitted with the beverage capsule through a sealing unit, thereby further preventing the beverage from entering the inner cavity of the beverage brewing device 1 from a top pierced hole. In this case, a sealing ring 14 may be adopted to be fitted over the piercing needle 13 on the cover body 12 and is arranged coaxially with the piercing needle 13. Certainly, apart from the sealing ring 14, other common sealing structures can also be adopted in the present embodiment.

The beverage brewing device 1 in the present embodiment can separate from a beverage machine body, and has a simple structure and is easy to remove.

As a part of the beverage machine body, the heating container is generally connected to the brewing device 1 through a machine nose 6 of the beverage machine body. For that reason, the cover body 12 is provided with a joint 17 connected with the beverage machine body. The joint 17 is connected with the piercing needle 13 on the cover body 12, and allows the water to enter the water inlet 15 through the joint 17. In this case, the joint 17 may be integrally formed with the cover body 12, thereby simplifying the manufacturing process.

It is worth mentioning that the joint 17 connected with the beverage machine body can also be formed and obtained by extending the piercing needle 13 to an upper surface of the cover body 12, in which case the piercing needle 13 is connected with the beverage machine body and allows the water to enter the water inlet 15 through the joint 17. In this case, the brewing device 1 has a simple structure and is easy to manufacture as well. If the joint 17 is integrally formed with the cover body 12, i.e., the piercing needle 13 is integrally formed with the cover body, the manufacturing process can be simplified to a greater extent. Certainly, regardless of a relationship between the piercing needle 13 and the joint 17, the piercing needle 13 can be integrally formed with the cover body 12, or the piercing needle 13 and the cover body 12 are fixedly connected after being formed separately.

Obviously, the joint 17 in the present embodiment further needs to satisfy the conveyance of water while satisfying the requirement for connection between the brewing device 1 and the beverage machine body, and hence the joint 17 is a structure having the hollow central section. Certainly, the connection between the brewing device 1 and the beverage machine body is not limited to listed conditions in the present embodiment, and any connections which satisfy the objective of beverage brewage may be included in the present invention.

For convenience of assembly of the beverage machine and in order to satisfy a force bearing requirement of the beverage brewing device 1 better, an annular flange 18 is provided at a position of the barrel body 11 of the brewing device 1 adjacent to an opening. In addition, in order to prevent contamination of the machine body due to a connection failure between the brewing device 1 and the beverage machine body, a vertical baffle may be provided to an upper surface of the annular flange 18. Further referring to FIG. 3, the vertical baffle is located at a periphery of the cover body 12, thereby intercepting the overflowing liquids.

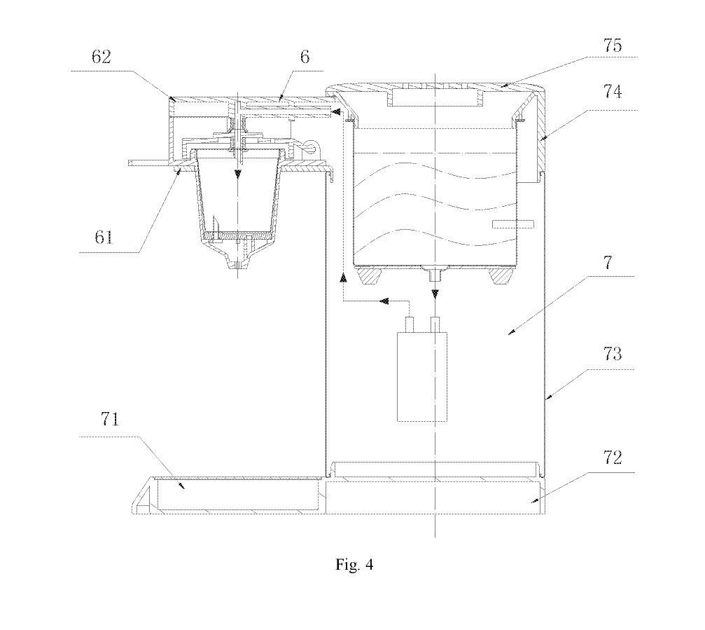

The present embodiment further provides a beverage machine, which includes the above-mentioned brewing system, the machine nose 6 and a mounting body 7, with reference to FIG. 4.

The machine nose 6 includes a supporting rail 61 and a machine nose shell 62 which are connected with each other. The supporting rail 61 is configured to mount the brewing device 1, such that the brewing device 1 can move along the supporting rail 61 and be fixed. Moreover, a pipeline is provided in the machine nose shell 62, the pipeline is connected with the water pump 5 through the piping, and when the brewing device 1 is fixed, the pipeline is communicated with the water inlet 15 of the brewing device 1. Obviously, in order to make the water in the pipeline of the machine nose shell 62 flow into the brewing device 1, the machine nose shell 62 may be disposed above the supporting rail.

The mounting body 7 includes a waste water box 71, a base 72, a housing 73, a fixing ring 74 and a top cap 75. The waste water box 71 is located below the machine nose 6, so as to make it convenient for collection of waste water. The boiler 2 and the water pump 5 are fixedly mounted in the housing 73, and the machine nose 6 is mounted to the housing 73. The top cap 75 is connected with the housing 73 through the fixing ring 74 to close the boiler 2. In this case the top cap 75 does not need to be seal-fitted with the boiler 2, but plays a role of dust prevention and shield to a certain extent. The waste water box 71 and the housing 73 are fixedly mounted to the base 72, and further referring to FIG. 4, the waste water box 71 is fixed to an upper left side of the base 72, while the housing 73 is fixed to an upper right side of the base 72. Materials of the housing 73 can be plastic, metal or other, thereby satisfying diversification of the production.

The beverage machine of the present embodiment can be applied in brewage of beverages such as coffee, milk tea and tea.

The present embodiment also provides a method for brewing the beverage by using the beverage machine of the present embodiment. The method includes the following steps:

S1, setting a heating temperature T for the water in the heating container, and heating the water in the heating container;

S2, starting the water pump 5 to operate when the water in the heating container reaches the set temperature T, so as to allow the water pump 5 to pump the water in the heating container into the brewing device;

S3, controlling the water pump 5 to continue operating for a period of time after the water in the heating container is drained and the beverage is acquired by the brewing machine, until the water pump 5 blow-dries the residual liquid in the capsule of the brewing device by drawing air.

Obviously, the water pump 5 in the present embodiment can not only satisfy the requirement for drawing the water, but also can produce the pressure by drawing the air. Moreover, since the water pump 5 draws the air and pumps the air into the capsule of the brewing device, to blow-dry the residual liquid in the capsule, the brewing device is easy to clean, and no residual beverage may drip everywhere to contaminate the ambient environment when the brewing device is taken out.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present invention. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present invention. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present invention, and changes, alternatives, and modifications can be made in the embodiments without departing from spirit, principles and scope of the present invention.

1. A brewing system for a beverage machine comprising:
a brewing device;
a heating device for supplying hot water to the brewing device, a heating container of the heating device being communicated with the atmosphere, and the heating container being connected with the brewing device through piping;
a water pump provided in the piping; and
a controller connected with the water pump, wherein when temperature of the water in the heating container reaches a predetermined value, the controller controls the water pump to pump water into the brewing device.

2. The brewing system according to claim 1, wherein the heating container is a boiler, the boiler is heated by a heating tray disposed to the boiler, and temperature of the water in the boiler is measured by a temperature sensor, the temperature sensor being connected with the controller.

3. The brewing system according to claim 2, wherein the heating tray is connected with a temperature controller and a fuse.

4. The brewing system according to claim 2, wherein a bottom surface of the boiler is a recessed surface.

5. The brewing system according to claim 1, wherein the brewing device comprises:
a barrel body for containing a beverage capsule, a bottom end of the barrel body being provided with a beverage outlet;
a cover body fitted with the barrel body and provided with a water inlet; and
a piercing needle separately provided to an inner bottom end of the barrel body and the cover body so as to pierce the beverage capsule.

6. The brewing system according to claim 5, wherein a central section of the piercing needle on the cover body is hollow and forms the water inlet; the piercing needle on the cover body is seal-fitted with the beverage capsule through a sealing ring, and the sealing ring is fitted over the piercing needle on the cover body and is arranged coaxially with the piercing needle.

7. The brewing system according to claim 6, wherein the piercing needle extends to an upper surface of the cover body and is connected with a beverage machine body, such that the water enters the water inlet from the beverage machine body.

8. The brewing system according to claim 5, wherein the cover body is in hinged connection with the barrel body.

9. A beverage machine comprising:
a brewing system for a beverage machine including:
a brewing device;
a heating device for supplying hot water to the brewing device, a heating container of the heating device being communicated with the atmosphere, and the heating container being connected with the brewing device through piping;
a water pump provided in the piping; and
a controller connected with the water pump, wherein when temperature of the water in the heating container reaches a predetermined value, the controller controls the water pump to pump water into the brewing device.

10. A beverage brewing method for the beverage machine according to claim 9, comprising following steps:
S1, setting a heating temperature T for water in a heating container, and heating the water in the heating container;
S2, starting a water pump to operate when the water in the heating container reaches the set temperature T, so as to allow the water pump to pump the water in the heating container into a brewing device;
S3, controlling the water pump to continue operating for a period of time after the water in the heating container is drained and a beverage is acquired by a brewing machine, until the water pump blow-dries residual liquids in a capsule of the brewing device by drawing air.
